(19) United States
(12) Patent Application Publication
(10) Pub. No.: US 2007/0114907 A1
(43) Pub. Date: May 24, 2007

(54) Three-Dimensional Luminescent Display and Method for Using the Same

(75) Inventors: Whe-Yi Chiang, Hsinchu City (TW); Ta-Ching Pong, Hsinchu City (TW)

Correspondence Address: WPAT, PC, 7225 BEVERLY ST., ANNANDALE, VA, 22003, US

(73) Assignee: LENTICS CORPORATION, Hsinchu City (TW)

(21) Appl. No.: 11/559,915

(22) Filed: Nov. 15, 2006

(30) Foreign Application Priority Data
Nov. 21, 2005 (TW) 094140758

(51) Int. Cl. H01J 1/62

(52) U.S. Cl. 313/483

(57) ABSTRACT

This invention provides a three-dimensional luminescent display, comprising: a first substrate, a second substrate, a plurality of light emitting devices provided between the first substrate and the second substrate, and a plurality of lenticular lenses to show 3D image.

Each light emitting device comprises a pixel and has a square shape, and the pixels are provided to form an N by M matrix (N and M are integers) and have a pitch of Xₚ inch (distance between two neighboring pixels along either the N direction or the M direction). The lenticular lenses form a linear array and the pitch of the lenticular lenses is Pₗₑₙₛ per inch (lines per inch; LPI). The light emitting devices are provided at the focal plane of the lenticular lenses. Moreover, Xₚ and Pₗₑₙₛ satisfy the following equation: 3*k*Xₚ*Pₗₑₙₛ=1 in which k is an integer greater than or equal to 1.

### BACKGROUND OF THE INVENTION

1. Field of the Invention

The present invention is generally related to a luminescent display for displaying three dimensional (3D) images and a method for using the same, and more particularly to a luminescent display comprising lenticular lenses to display 3D effects and a method for using the same.

2. Description of the Prior Art

In the field of three-dimensional displays (3D displays), recently because of the progress in the high processing speed and broad bandwidths together with the advance of the high resolution flat panel display, the 3D displays become technically viable and the commercialization of the 3D displays is expected to be the next revolution in the display application.

In general, 3D displays can be classified into head-mounted displays and distant view displays. The distant view displays have various types, such as volumetric, holographic and flat-screen types. The flat screen type 3D displays include auto-stereoscopic and glasses types. However, wearing glasses is quite inconvenient for viewers. Moreover, the auto-stereoscopic displays using parallax barriers or lenticular lenses have the advantages of brightness and wide viewing angles. Thus, most of the auto-stereoscopic 3D displays are based on parallax barrier or lenticular technology.

A lenticular 3D display comprises an array of cylindrical lenses placed in front of interlaced pictures of a given scene from different viewing angles. As shown in FIG. 1, the different viewing angle of the left eye and the right eye causes them to see different images (image A for the right eye and image B for the left eye) through the lenticular lenses. Thus, stereoscopic vision with motion can be seen while a series of images are playing.

### SUMMARY OF THE INVENTION

In light of the above-mentioned matter, the present invention provides a luminescent display comprising lenticular lenses to display 3D effects and a method for using the same.

One object of the present invention is to provide a three-dimensional (3D) luminescent display comprising a first substrate having a first surface and a second surface and a second substrate having a first surface and a second surface. The first surface of the second substrate is contacted with the second surface of the first substrate. A plurality of light emitting devices provided between the first substrate and the second substrate. Each light emitting device comprises a pixel and has a square shape. The pixels form an N by M matrix (N and M are integers) and have a pitch of Xₚ inch (distance between two neighboring pixels along either the N direction or the M direction). In addition, a plurality of lenticular lenses provided on the first surface of the first substrate to form a linear array on the surface in which each inch has Pₗₑₙₛ lenticular lenses (lines per inch; LPI). The light from the light emitting devices outputted to the first surface of the first substrate and the plurality of light emitting devices are provided at the focal plane of the lenticular lenses and Xₚ and Pₗₑₙₛ satisfy the following equation: 3*k*Xₚ*Pₗₑₙₛ=1 in which k is an integer greater than or equal to 1.

The light emitting device emitting red, green, or blue light comprises a red, green or blue pixel, respectively. The red, green and blue pixels are provided in order of R, G, B, R, G, B . . . in the M direction of the N by M matrix and the N direction is parallel to the lenticular lenses. Preferably, a protection layer is provided on the light emitting device.

The first substrate, the second substrate or both can be made from plastic materials. The display may further comprise a Fresnel lens for adjusting viewing distance. The lenticular lenses are formed by curing the resin composition on the substrate. The electrodes of the light emitting devices are transparent and a reflection layer is provided on the second surface of the second substrate. Furthermore, the reflection layer has prismatic structure.

Another object of the present invention is to provide a three-dimensional (3D) luminescent display, comprising a first substrate having a first surface and a second surface and a second substrate having a first surface and a second surface. The first surface of the second substrate is contacted with the second surface of the first substrate. A plurality of light emitting devices provided between the first substrate and the second substrate. Each light emitting device comprises a pixel and has a square shape. The pixels are provided to form an N by M matrix (N and M are integers) and have a pitch of Xₚ inch (distance between two neighboring pixels along either the N direction or the M direction). A plurality of lenticular lenses provided on the second surface of the second substrate to form a linear array on the surface, wherein each inch has Pₗₑₙₛ lenticular lenses (lines per inch; LPI). The light from the light emitting devices outputted to the second surface of the second substrate and the plurality of light emitting devices are provided at the focal plane of the lenticular lenses and Xₚ and Pₗₑₙₛ satisfy the following equation: 3*k*Xₚ*Pₗₑₙₛ=1 in which k is an integer greater than or equal to 1.

The light emitting device emitting red, green, or blue light comprises a red, green or blue pixel, respectively, and the red, green and blue pixels are provided in order of R, G, B, R, G, B . . . in the M direction of the N by M matrix and the N direction is parallel to the lenticular lenses. Preferably, a protection layer is provided on the light emitting device.

The first substrate, the second substrate or both can be made from plastic materials. The display may further comprise a Fresnel lens for adjusting viewing distance. The lenticular lenses are formed by curing the resin composition on the substrate. The electrodes of the light emitting devices are transparent and a reflection layer is provided on the second surface of the second substrate. Furthermore, the reflection layer has prismatic structure.

The light emitting devices are organic light emitting diodes, plasma discharge or field emission devices.

Another object of the present invention is to provide a method for using the three-dimensional luminescent display. At first, the three-dimensional luminescent display according to the present invention is provided. 3*k images for multiple viewpoints on the three-dimensional luminescent display are simultaneously displayed to show 3D effect. The 3*k images are interlaced along the M direction of the N by M matrix to form a composite image on the display and the 3*k pixels (k sets of R, G, B pixels) along the N direction are treated as one displaying pixel to show the same image data.

According to above-mentioned objectives, the present invention discloses a luminescent display comprising lenticular lenses to display 3D effects and a method for using the same. Because the luminescent displays have the advantages of high luminance, quick response time, high resolution, compared to the LCD, the 3D display according to the present invention can display 3D pictures with high quality and high brightness.

### BRIEF DESCRIPTION OF THE DRAWINGS

FIG. 1 shows the different viewing angle of the left eye and the right eye;

FIG. 2 shows an explosive schematic diagram illustrating a 3D luminescent display according to one embodiment of the present invention;

FIG. 3 shows a top view of the second surface of the first substrate;

FIG. 4A shows a top view of the first surface of the first substrate 101;

FIG. 4B shows a side view of the first surface of the first substrate 101; and,

FIG. 5 shows an explosive schematic diagram illustrating a 3D luminescent display according to another embodiment of the present invention.

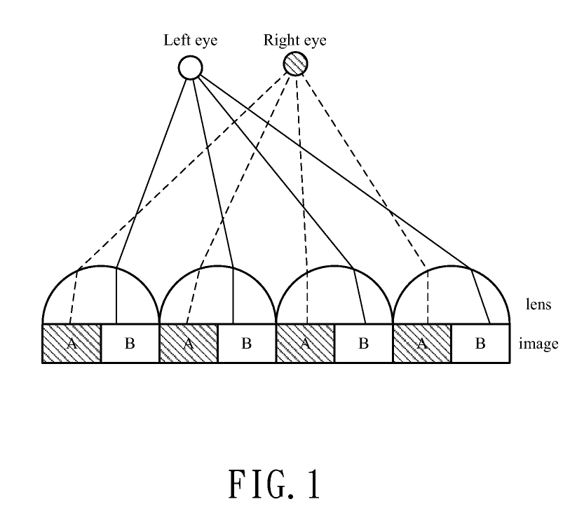

### DESCRIPTION OF THE PREFERRED EMBODIMENTS

What is probed into the invention is a luminescent display comprising lenticular lenses to display 3D effects and a method for using the same. Detail descriptions of the structure and elements will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

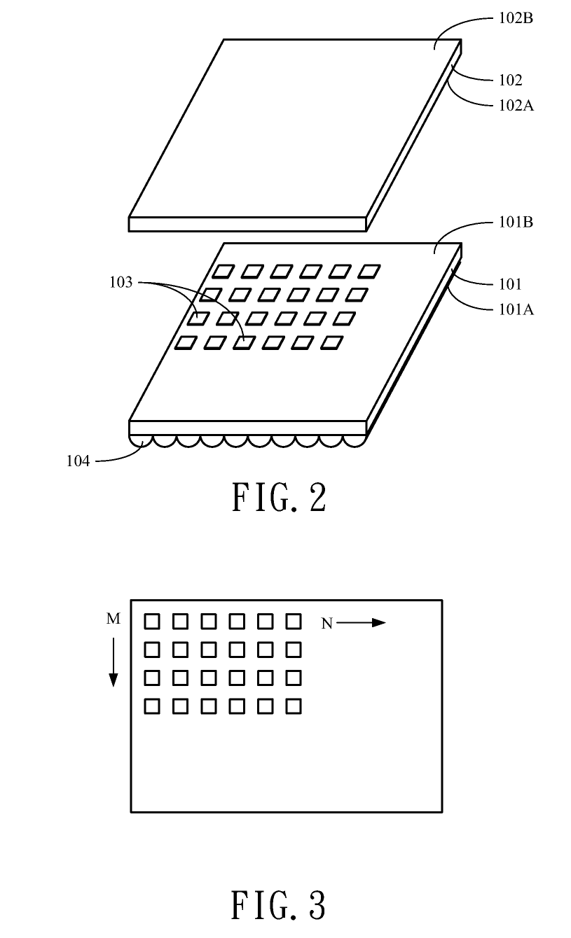

A first embodiment of the present invention discloses a 3D luminescent display as shown in FIG. 2. A first substrate 101 made from glass has a first surface 101A and a second surface 101B. A second substrate 102 made from glass has a first surface 102A and a second surface 102B.

A plurality of light emitting devices 103 are provided on the second surface 101B of the first substrate 101. Each light emitting device comprises a pixel and every pixel has a square shape. The distance between the two neighboring pixels (pitch) is 0.00278 inch (0.0706 mm). As shown in FIG. 3, the pixels form a matrix with N×M pixels where N=768 (256*3) and M=768.

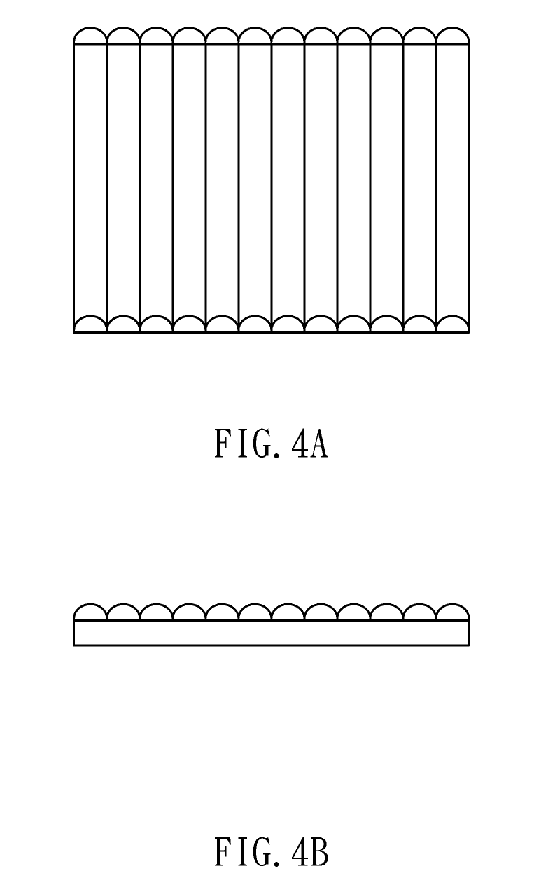

A plurality of linear lenticular lenses are provided on the first surface 101A of the first substrate 101. As shown in FIGS. 4A and 4B, these lenticular lenses 104 form a linear array. There are 30 linear lenticular lenses per inch, i.e. 30LPI. The lenticular lenses can be obtained from a commercial lenticular sheet. Other than cylindrical lenses, the lenticular lenses can be elliptical lenses for improving image aberration.

The light from the light emitting devices 103 outputted to the first surface 101A of the first substrate 101. The light emitting devices 103 are provided at the focal plane of the lenticular lenses. According to the above, Xₚ=0.00278 inch and Pₗₑₙₛ=30. Xₚ and Pₗₑₙₛ satisfy the following equation: 3*k*Xₚ*Pₗₑₙₛ=1 where k=4. The display according to the embodiment of the invention can show twelve 3D images. Each image is a full-color image with 64×64 pixels. The light emitting device emitting red, green, or blue light comprises a red, green or blue pixel, respectively, and the red, green and blue pixels are provided in order of R, G, B, R, G, B . . . in the M direction of the N by M matrix and the N direction is parallel to the lenticular lenses. In the M direction, every 12 pixels display the same data.

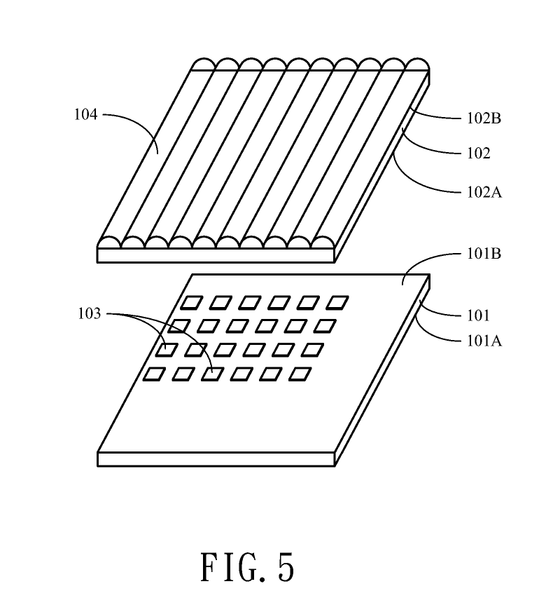

A second embodiment of the present invention discloses a 3D luminescent display as shown in FIG. 5. A first substrate 101 made from glass has a first surface 101A and a second surface 101B. A second substrate 102 made from glass has a first surface 102A and a second surface 102B.

A plurality of light emitting devices 103 are provided on the second surface 101B of the first substrate 101. Each light emitting device comprises a pixel and every pixel has a square shape. The distance between the two neighboring pixels (pitch) is 0.00278 inch (0.0706 mm). Like those in the first embodiment shown in FIG. 3, the pixels also form a matrix with N×M pixels where N=768 (256*3) and M=768.

A plurality of linear lenticular lenses are provided on the second surface 102B of the second substrate 102. Like those in the first embodiment shown in FIGS. 4A and 4B, the lenticular lenses 104 form a linear array. There are 30 linear lenticular lenses per inch, i.e. 30LPI. The lenticular lenses can be obtained from a commercial lenticular sheet. Other than cylindrical lenses, the lenticular lenses can be elliptical lenses for improving image aberration.

The light from the light emitting devices 103 outputted to the second surface 102B of the second substrate 102. The light emitting devices 103 are provided at the focal plane of the lenticular lenses. According to the above, Xₚ=0.00278 inch and Pₗₑₙₛ=30. Xₚ and Pₗₑₙₛ satisfy the following equation: 3*k*Xₚ*Pₗₑₙₛ=1 where k=4. The display according to the embodiment of the invention can show twelve 3D images. Each image is a full-color image with 64×64 pixels. The light emitting device emitting red, green, or blue light comprises a red, green or blue pixel, respectively, and the red, green and blue pixels are provided in order of R, G, B, R, G, B . . . in the M direction of the N by M matrix and the N direction is parallel to the lenticular lenses. In the M direction, every 12 pixels display the same data.

A third embodiment of the present invention discloses a 3D luminescent display, which is the same as the one in the second embodiment except that the first substrate 101 or the second substrate 102 is made from plastics, such as PET substrate and the light emitting devices 103 are provided with a protection layer. The light emitting devices are organic light emitting diodes. The display may further comprise a Fresnel lens for adjusting viewing distance.

A fourth embodiment of the present invention discloses a method for using the 3D luminescent display. At first, the 3D luminescent display according to the present invention is provided. Twelve (3*4) images for multiple viewpoints on the three-dimensional luminescent display are simultaneously displayed to show 3D effect. The 12 images are interlaced along the M direction of the N by M matrix to form a composite image on the display and the 12 pixels (4 sets of R, G, B pixels) along the N direction are treated as one displaying pixel to show the same image data.

To sum up, the present invention discloses a luminescent display comprising lenticular lenses to display 3D images. Furthermore, the present invention discloses a method for using the 3D luminescent display. Because the luminescent displays have the advantages of high luminance, quick response time, high resolution, compared to the LCD, the 3D display according to the present invention can display 3D pictures with high quality and high brightness.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A three-dimensional (3D) luminescent display, comprising:
a first substrate having a first surface and a second surface;
a second substrate having a first surface and a second surface, wherein the first surface of the second substrate is contacted with the second surface of the first substrate;
a plurality of light emitting devices provided between the first substrate and the second substrate, wherein each light emitting device comprises a pixel and has a square shape, and the pixels are provided to form a N by M matrix (N and M are integers) and have a pitch of Xₚ inch (distance between two neighboring pixels along either the N direction or the M direction); and,
a plurality of lenticular lenses provided on the first surface of the first substrate to form a linear array on the surface, wherein each inch has Pₗₑₙₛ lenticular lenses (lines per inch; LPI);
wherein the light from the light emitting devices outputted to the first surface of the first substrate and the plurality of light emitting devices are provided at the focal plane of the lenticular lenses and Xₚ and Pₗₑₙₛ satisfy the following equation: 3*k*Xₚ*Pₗₑₙₛ=1 in which k is an integer greater than or equal to 1.

2. The 3D luminescent display according to claim 1, wherein the light emitting device emitting red, green, or blue light comprises a red, green or blue pixel, respectively, and the red, green and blue pixels are provided in order of R, G, B, R, G, B . . . in the M direction of the N by M matrix and the N direction is parallel to the lenticular lenses.

3. The 3D luminescent display according to claim 1, wherein a protection layer is provided on the light emitting device.

4. The 3D luminescent display according to claim 1, wherein the first substrate, the second substrate or both are plastic.

5. The 3D luminescent display according to claim 1, further comprising a Fresnel lens for adjusting viewing distance.

6. The 3D luminescent display according to claim 1, wherein the lenticular lenses are formed by curing the resin composition on the substrate.

7. The 3D luminescent display according to claim 1, wherein the electrodes of the light emitting devices are transparent and a reflection layer is provided on the second surface of the second substrate.

8. The three-dimensional (3D) luminescent display according to claim 7, wherein the reflection layer has prismatic structure.

9. A three-dimensional (3D) luminescent display, comprising:
a first substrate having a first surface and a second surface;
a second substrate having a first surface and a second surface, wherein the first surface of the second substrate is contacted with the second surface of the first substrate;
a plurality of light emitting devices provided between the first substrate and the second substrate, wherein each light emitting device comprises a pixel and has a square shape, and the pixels are provided to form a N by M matrix (N and M are integers) and have a pitch of Xₚ inch (distance between two neighboring pixels along either the N direction or the M direction); and,
a plurality of lenticular lenses provided on the second surface of the second substrate to form a linear array on the surface, wherein each inch has Pₗₑₙₛ lenticular lenses (lines per inch; LPI);
wherein the light from the light emitting devices outputted to the second surface of the second substrate and the plurality of light emitting devices are provided at the focal plane of the lenticular lenses and Xₚ and Pₗₑₙₛ satisfy the following equation: 3*k*Xₚ*Pₗₑₙₛ=1 in which k is an integer greater than or equal to 1.

10. The 3D luminescent display according to claim 9, wherein the light emitting device emitting red, green, or blue light comprises a red, green or blue pixel, respectively, and the red, green and blue pixels are provided in order of R, G, B, R, G, B . . . in the M direction of the N by M matrix and the N direction is parallel to the lenticular lenses.

11. The 3D luminescent display according to claim 9, wherein a protection layer is provided on the light emitting device.

12. The 3D luminescent display according to claim 9, wherein the first substrate, the second substrate or both are plastic.

13. The 3D luminescent display according to claim 9, further comprising a Fresnel lens for adjusting viewing distance.

14. The 3D luminescent display according to claim 9, wherein the electrodes of the light emitting devices are transparent and a reflection layer is provided on the second surface of the second substrate.

15. The 3D luminescent display according to claim 15, wherein the reflection layer has prismatic structure.

16. The 3D luminescent display according to claim 1, wherein the light emitting devices are organic light emitting diodes.

17. The 3D luminescent display according to claim 9, wherein the light emitting devices are organic light emitting diodes.

18. The 3D luminescent display according to claim 1, wherein the light emitting devices are plasma discharge or field emission devices.

19. The 3D luminescent display according to claim 9, wherein the light emitting devices are plasma discharge or field emission devices.

20. A method for using the three-dimensional luminescent display, comprising:
providing the three-dimensional luminescent display according to claim 1 or claim 9 wherein the light emitting device emitting red, green, or blue light comprises a red (R), green (G) or blue (B) pixel, respectively, and the red, green and blue pixels are provided in order of R, G, B, R, G, B . . . in the M direction of the N by M matrix and the N direction is parallel to the lenticular lenses;
simultaneously displaying 3*k images for multiple viewpoints on the three-dimensional luminescent display to show 3D effect wherein the 3*k images are interlaced along the M direction of the N by M matrix to form a composite image on the display and the 3*k pixels (k sets of R, G, B pixels) along the N direction are treated as one displaying pixel to show the same image data.
